(19) United States
(12) Patent Application Publication
(10) Pub. No.: US 2025/0333291 A1
(43) Pub. Date: Oct. 30, 2025

(54) DEVICE FOR THE PRESSURE TESTING, EVACUATION AND FILLING OF AN ASSEMBLY

(71) Applicant: Dürr Somac GmbH, Stollberg (DE)

(72) Inventor: Carsten Wöhner, Stuttgart (DE)

(21) Appl. No.: 18/867,905

(22) PCT Filed: May 13, 2023
(86) PCT No.: PCT/DE2023/000034

§ 371 Date: Nov. 21, 2024

(30) Foreign Application Priority Data
May 21, 2022 (DE) 10 2022 001 796.2

(51) Int. Cl. B67D 7/32; B67D 7/02; B67D 7/72; F17C 13/04

(52) U.S. Cl. CPC B67D 7/3245; B67D 7/0277; B67D 7/725; F17C 13/04

(57) ABSTRACT

The invention relates to a device for pressure testing, evacuation, and/or filling of a non-vacuum-resistant or non-pressure-resistant assembly by means of vacuum pressure filling or vacuum volume filling, the device comprising a vacuum chamber for accommodating the assembly to be filled and an adapter for filling the assembly to be filled. The problem of the invention is that of providing a respective device which has a compact design with small volumes to enable short evacuation and ventilation times. At the same time, consumption of auxiliary gas is to be kept to a minimum and good handling for an automation system is to be achieved. The problem is solved by releasably assembling the vacuum chamber of the device from a first and a second housing component, specific designs being proposed for these components.

### RELATED APPLICATIONS

This application is a national phase of international application No. PCT/DE2023/000034, filed on May 13, 2023, and claiming the benefit of German application No. 10 2022 001 796.2, filed on May 21, 2022, both of which are incorporated herein by reference in their entirety and for all purposes.

### FIELD OF THE DISCLOSURE

The disclosure relates to a device for the pressure testing, evacuation, and/or filling of a preferably non-vacuum-resistant or non-pressure-resistant assembly by means of a vacuum pressure filling or a vacuum volume filling, the device comprising a chamber for accommodating the assembly to be filled and an adapter for pressure testing, evacuation, and/or filling of the assembly.

### BACKGROUND

For various technical applications, liquids or gases must be supplied as service fluids to an assembly, a workpiece, or a technical equipment system. In the context of the present description of examples disclosed herein, only the term “assembly” is used below for such technical objects. An assembly can include multiple workpieces and/or subsystems. To enable air-free filling of assemblies, pressure filling is preferred, which is often additionally supported by means of vacuum or negative pressure.

For the purposes of examples disclosed herein, positive pressure is understood to mean a pressure level that is higher than the ambient pressure. A vacuum is here understood to mean a pressure level that is below the ambient pressure.

Filling is usually divided into multiple process steps which are required for testing (e.g. pressure leak testing) and preparing (e.g. evacuating) the filling as well as for the actual filling operation. If the assembly to be filled is evacuated first, the gases contained in the assembly can be extracted so that a vacuum is achieved in the assembly before filling with the respective filling medium.

A typical area of application for vacuum pressure filling is the automotive industry. Vehicles are filled with the necessary service fluids at the manufacturers' assembly lines. The service fluids are fed from filling systems by means of lines and filling adapters into the vehicle assemblies to be filled (circuits, containers/tanks, etc.). Such applications are known, for example, from DE 197 00 436 C2, DE 10 2007 029 020 A1, and DE 10 2014 011 611 B4 and do not cause any problems due to principle, because the vehicle assemblies to be filled are designed to be pressure-resistant and vacuum-resistant.

However, if vacuum pressure filling is to be used for non-pressure-resistant or non-vacuum-resistant assemblies, the assembly may collapse when subjected to pressure or vacuum. For this reason, additional process and/or equipment-related aspects must be taken into account for such applications to be able to fill the respective assembly.

### SUMMARY

The problem addressed by examples disclosed herein is to create a device for the pressure testing, evacuation, and/or filling of a non-vacuum-resistant or non-pressure-resistant assembly, which has a compact design with small volumes to enable short evacuation and ventilation times. At the same time, consumption of auxiliary gas is to be kept to a minimum and good handling for an automation system is to be achieved.

This problem is solved by the subject matter of the independent claims. Advantageous developments are the subject matter of the dependent claims.

One idea is to provide a device for the pressure testing, evacuation, and/or filling of an assembly according to claim 1. The device includes a first housing component and a second housing component. The second housing component is coupled to the first housing component such that a chamber is formed to accommodate the assembly to be treated. The device comprises an adapter for pressure testing, evacuating, and/or filling the assembly.

In one variant the chamber can be designed as a vacuum chamber. A vacuum chamber is a chamber in which a negative pressure can be implemented relative to the ambient pressure.

In an alternative variant, the chamber can be designed as a pressure chamber. A pressure chamber is a chamber in which a positive pressure can be implemented relative to the ambient pressure.

In one variant, the first housing component can be designed as a vacuum pressure trough. A vacuum pressure trough is understood to be a trough-shaped housing component that can be used to form part of both a pressurized and a vacuum chamber.

In one variant, the second housing component can be designed as a base plate.

This makes it possible to provide a device into which an assembly to be treated can easily be inserted.

According to a preferred embodiment of the device, the adapter comprises an outlet piece. The outlet piece is aligned and configured such that, during a pressure testing, evacuation, and/or filling process, the outlet piece can be coupled in a fluid-tight manner with an opening of an assembly to be treated.

In an alternative embodiment, the outlet piece can have a separate seal. This allows different pressures to be set and maintained in the chamber and in the assembly.

In another alternative embodiment, the adapter can have a movable piston. The movable piston is coupled to the outlet piece. The movable piston can be arranged in the adapter so that it can be moved and controlled (e.g. hydraulically or pneumatically) such that the outlet piece can be pushed into the opening of the assembly with the aid of the piston.

According to another preferred embodiment, the device comprises a first shaped piece with the aid of which an assembly to be treated can be aligned relative to the adapter. The device also comprises a shaped piece holder. The first shaped piece is adapted to the dimensions and/or shape of the assembly such that the outlet piece can be coupled to the opening in a fluid-tight manner during a pressure testing, evacuation, and/or filling process.

The first shaped piece can be made of plastic, metal, or ceramic. In an alternative embodiment, the shaped piece can be manufactured integrally with the first housing component.

According to another preferred embodiment, the device comprises a fixing device with a clamping drive for fixing the position of the assembly, wherein the clamping drive is equipped with interchangeable second and third shaped pieces for fixing the position of the assembly.

This ensures that the assemblies to be treated are held securely. The fixing device also makes it possible to fix the position and compensate for size differences between the assemblies.

According to another preferred embodiment, the device comprises a line port and/or a first sensor port. The line port can preferably include a vacuum port and an auxiliary gas port. Preferably, the ports can be integrated into a single structural unit. The adapter comprises a filling port, a gas supply port, and/or a second sensor port.

A vacuum port is understood herein to be a port by means of which a pressure below the ambient pressure can be generated in the chamber of the device. The vacuum port can include a valve for opening and/or closing the port.

In the present case, an auxiliary gas port is understood to be a port by means of which a fluid can be introduced into the chamber of the device. The fluid can be a gas or a liquid. This can be used to generate a positive pressure relative to the ambient pressure in the chamber. The auxiliary gas port can include a valve for opening and closing the port.

A filling port is understood herein to be a port by means of which a fluid can be introduced into the assembly. The filling port can include a valve for opening and closing the port. A gas or liquid can be provided as the fluid.

A gas supply port is understood herein to be a port by means of which a negative pressure can be generated relative to the ambient pressure in the assembly or an auxiliary gas can be introduced into the assembly.

A first and a second sensor port are each understood to be a port for a sensor. Preferably, a pressure sensor can be provided as a sensor. A pressure sensor can be used to measure the respective actual pressure by means of the sensor port. The first sensor port enables pressure measurement in the chamber of the device. The second sensor port provides a pressure measurement in the assembly.

According to another preferred embodiment, the ports of the device and the ports of the adapter are arranged on the same side of the device. Preferably, the ports are arranged on the side of the second housing component. This enables simplified cable routing. Accessibility to the device can also be improved.

According to another preferred embodiment, the device comprises a volume ballast. The volume ballast is interchangeable and is configured and/or selected depending on the assembly to be treated. The volume ballast is arranged inside the chamber such that a free residual volume is reduced.

A volume ballast is understood to be a displacement body. Preferably, the device can also comprise a plurality of volume ballasts. This makes it possible to minimize the space in the chamber to be evacuated or filled. This means that less fluid has to be removed from or added to the chamber to set the desired pressure inside the chamber.

According to another preferred embodiment, the second housing component is aligned with the first housing component by means of a positioning device such that the outlet piece of the adapter for pressure testing, evacuation, and/or filling can be connected in a sealed manner to the opening of the assembly to be treated.

In one variant, the positioning device is designed as a centering device. Preferably, centering can be achieved using a centering pin, an internal or external stop, or with the aid of a tongue and groove connection. In a preferred variant, the tongue and groove connection can be implemented as a circumferential collar.

According to another preferred embodiment, a closure element is associated with the first housing component and the second housing component. The closure element releasably connects the first housing component to the second housing component. A seal is provided on the first housing component and/or the second housing component in the coupling area of the housing components.

In one variant, a seal is arranged on the first housing component and another seal is arranged on the second housing component. This makes it possible to achieve a particularly good seal between the chamber and its environment.

A closure element is a separate component that releasably connects the two housing components. In one variant, the closure element can be attached to one of the two housing components. In an alternative variant, the closure element can be configured as a separate component which applies a force to the first and second housing components to connect the two housing components. In another variant, multiple similar closure elements are provided.

According to another preferred embodiment, the first housing component is configured as a vacuum pressure trough. The second housing component is configured as a base plate. The chamber is configured as a vacuum chamber and the sensor is configured as a vacuum pressure sensor. The base plate comprises a structural unit on its upper side that can be operatively connected to the vacuum chamber and has ports for evacuating the vacuum chamber and for feeding auxiliary gas into the vacuum chamber as well as a vacuum pressure sensor. The base plate has an opening in which a filling adapter is supported. The base plate comprises at least two closure elements arranged opposite one another at the front end sections for an operative connection with the vacuum pressure trough. Furthermore, the base plate comprises at least one seal on its underside and a centering device for an operative connection with the vacuum pressure trough as well as a fixing device with a clamping drive for fixing the position of the assembly to be filled.

One embodiment proposes that the closure elements on the base plate are designed as pawls and have a contour that is congruent with the contour on the associated section of the vacuum pressure trough.

Another embodiment proposes that the seal on the base plate is designed with two round seals running parallel to each other, each of which being arranged in a groove on the underside of the base plate.

Another embodiment proposes that the centering devices on the base plate are designed as locking pins and have a contour that is congruent with the contour of an opening on the associated section of the vacuum pressure trough.

The vacuum pressure trough has a U-shaped cross-section. The upper end section of the side walls has a flange-like, circumferential projection that comprises a section leading outwards and a section leading inwards. The section leading outwards has a contour that is congruent with the contour of the pawls on the closure elements on the associated section of the base plate. The section leading inwards has openings that are congruent with the contour of the locking pins on the associated section of the base plate.

One embodiment proposes that the vacuum pressure trough is equipped with exchangeable shaped pieces on the upper side of its base surface for fixing the position of the assembly to be filled.

Another embodiment proposes that a batch-specific volume ballast can be arranged on the upper side of the base surface of the vacuum pressure trough. This is preferably designed such that the free residual volume within the vacuum pressure trough is reduced as far as possible. In a modified embodiment, the batch-specific volume ballast can also be provided elsewhere within the vacuum chamber.

The technical solution according to the invention is suitable for numerous applications for pressure testing, evacuation, and filling of non-vacuum-resistant or non-pressure-resistant assemblies by means of vacuum pressure filling or vacuum volume filling. Irrespective of the specific area of application, there are the following advantages over the previously known proposed solutions:

A two-part vacuum chamber is designed, which closes around a fixed assembly. This makes the vacuum chamber easy to load, so that it is also suitable for automatic operation and can be easily integrated into automated production lines.

The vacuum chamber only has a small volume, which can be further reduced or optimized by a ballast volume. The small volume results in low consumption of auxiliary gas. Furthermore, the small volume allows rapid pressure changes in the vacuum chamber, which results in an overall fast evacuation and pressure control behavior.

The vacuum or pressure is measured directly at the assembly. The seal at the filling opening of the assembly does not have to be able to seal large pressure differences because there is no large pressure difference between the external and internal pressure of the assembly. The sealing makes it possible to use different media to achieve pressure inside and outside the assembly.

During filling, the pressure in the assembly can be increased significantly without creating a pressure difference on the outer wall of the assembly. This means that porous surfaces in the assembly can be impregnated significantly faster. Ideally, the predefined total filling quantity can be filled in one step. This, in turn, speeds up subsequent process steps and avoids subsequent refilling or filling to the target volume.

Finally, controlled pressure equalization after filling is possible, if necessary also combined with an adjustment of the filling level by suctioning back excess liquid. This prevents any dripping at the filling adapter and consequently contamination of the surface of the assembly around the filling opening after the filling adapter has been released from its adapted position on the assembly.

Another idea of the invention is to provide a method for pressure testing, evacuation, and/or filling of an assembly. The method comprises the following steps:

Providing a device with an adapter for accommodating an assembly to be treated. Inserting the assembly to be treated into the device. Closing the device such that the device forms a chamber which is fluid-tight towards the environment and in which the assembly is arranged.

Filling the assembly with a fluid at a defined positive pressure or a defined volume over a predefined time, up to a predefined volume and/or a predefined pressure. This can be used to ensure proper filling of an assembly.

According to a preferred embodiment of the method, the method comprises the following further steps:

Fluid-tight coupling of the adapter with an opening in the assembly before the assembly is filled at a defined positive pressure. Pressurizing the chamber with a defined first negative pressure and the assembly with a defined second negative pressure such that a virtually constant pressure ratio is established between the pressure in the chamber and the pressure inside the assembly. Pressurization takes place before the assembly is filled at a defined positive pressure. The chamber is then filled with an auxiliary gas at a defined positive pressure depending on the pressure specified or measured in the assembly so that there is a predefined positive pressure in the assembly relative to the pressure in the chamber. After completion of the specified filling of the assembly, the auxiliary gas in the chamber is evacuated, preferably by means of a pump, and the pressure in the chamber is set to ambient pressure.

In one variant, the pressures present in the chamber and in the assembly can be measured before the assembly is filled at a defined positive pressure. This can be used to check whether the defined negative pressures have been set in the chamber and in the assembly.

According to another preferred embodiment of the method, the method comprises the following further steps after measuring the pressures in the chamber and in the assembly:

Changing the set pressure in the chamber and/or the assembly. Re-measuring the set pressures in the chamber and/or the assembly. Calibrating the measured pressures of the chamber and/or the assembly before and after the pressure change.

This can be used to check the assembly for potential leaks.

According to another preferred embodiment of the method, the method comprises the following further steps:

Providing a first shaped piece. Inserting the first shaped piece into the device, wherein the first shaped piece is aligned with a shaped piece receptacle of the device. Gripping an assembly to be treated with a fixing device of the device from a storage location. Inserting the gripped assembly into the device such that the assembly is aligned for fluid-tight coupling with the adapter using the first shaped piece. This means that no separate device is required to grip the assembly to be treated from a storage location.

Other important features and advantages of examples disclosed herein are apparent from the dependent claims, from the drawings, and from the associated description of the figures with reference to the drawings.

It is understood that the features mentioned above and the features to be explained below cannot only be used in the respective combinations described but also in other combinations or by themselves, without deviating from the scope of examples disclosed herein.

Preferred exemplary embodiments of the invention are shown in more detail in the drawings and will be explained in the description below, wherein like reference symbols refer to like or similar or functionally identical components.

### BRIEF DESCRIPTION OF THE DRAWINGS

FIG. 1 shows a schematic sketch of a first device according to examples disclosed herein;

FIG. 2 shows a schematic sketch of a second device according to examples disclosed herein in a first operating position;

FIG. 3 shows the second device in a second operating position;

FIG. 4 shows the second device in a third operating position;

FIG. 5 shows the second device in a fourth operating position;

FIG. 6 shows a schematic sketch of a third device according to examples disclosed herein;

FIG. 7 shows a schematic sketch of a fourth device according to examples disclosed herein;

FIG. 8 shows a plan view of a schematic sketch of the fixing device of the first device.

### DETAILED DESCRIPTION OF THE DRAWINGS

The figures show devices A, B, C and D, which are designed for pressure testing, evacuation, and/or filling of non-vacuum-resistant or non-pressure-resistant assemblies 1 by means of vacuum pressure filling or vacuum volume filling.

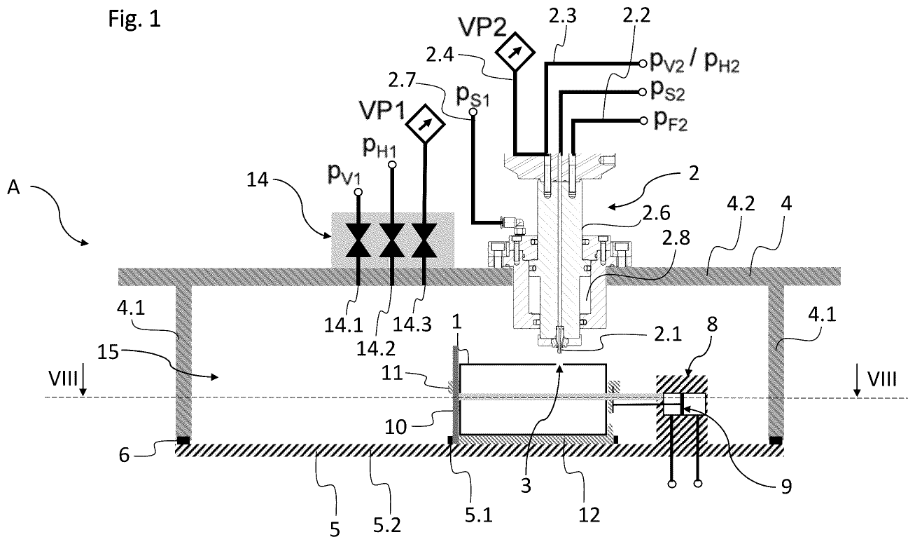

The first device A (FIG. 1) includes a first housing component 5 and a second housing component 4. The second housing component 4 is shaped like a trough, such that it surrounds an inner working volume in the form of a chamber 15 on multiple sides. In particular, the second housing component 4 includes both multiple side walls 4.1 and a ceiling wall 4.2 in integral construction. The first housing component 5, on the other hand, is largely flat in the form of a ground plate 5.2. In a preferred embodiment, the housing components 4, 5 are made of a plastic, a plastic derivative, a metal, and/or ceramics. In one variant, the housing components 4, 5 can be made of the same materials. In an alternative variant, the first housing component 5 and the second housing component 4 are each made of different materials. In a preferred embodiment, the first housing component 5 is made of a metallic material, while the second housing component 4 is made of a plastic. Multiple openings for the ports 14.1, 14.2, 14.3 and an opening for an adapter 2 are provided in the second housing component 4. The two housing components 4, 5 are aligned against each other with the aid of a positioning device (not shown) and coupled to one another as shown in FIG. 1. The coupling of the two housing components 4, 5 can be implemented with a bayonet connection, a screw connection, or a clip connection (not shown).

A seal 6 is provided in the coupling area to provide a fluid-tight connection. The seal 6 can be made of a typical sealing material. Preferably, a polyamide (PA), a nitrile-butadiene rubber (NBR), an ethylene-propylene-diene (monomer) rubber (EPDM), a fluorine rubber mixture (FKM), or a silicone is used as the sealing material.

The two housing components 4, 5 together enclose and delimit the chamber 15. In one variant, the chamber 15 can be configured as a pressure chamber. In a pressure chamber, a positive pressure relative to the ambient pressure is provided in the chamber 15 at least some of the time. In an alternative embodiment, the chamber 15 can also be configured as a vacuum chamber. In a vacuum chamber, a negative pressure relative to the ambient pressure is occasionally applied in the chamber 15. In another alternative embodiment, the chamber 15 can be configured as a vacuum pressure chamber. Both negative pressure and positive pressure can be alternately provided in chamber 15 as follows: First, a vacuum can be generated in chamber 15 by evacuation. The pressure can then be increased by filling the chamber with a fluid medium such that the negative pressure is first neutralized to ambient pressure and then a positive pressure is generated in the chamber 15 by further filling.

The pressures of the chamber 15 can be adjusted by means of a vacuum port 14.1 and/or an auxiliary gas port 14.2 by evacuating by means of the vacuum port 14.1 and filling by means of the auxiliary gas port 14.2 with a fluid medium in the form of an auxiliary gas. The vacuum port 14.1 and the auxiliary gas port 14.2 are preferably integrated in the second housing component 4 or permanently connected to the second housing component 4.

The second housing component 4 can also comprise a first sensor port 14.3, by means of which a measured pressure value in the chamber 15 can be tapped and fed to a sensor.

In a preferred variant, the ports 14.1, 14.2 and 14.3 are combined in a single structural unit 14 (see FIG. 1). The structural unit 14 is preferably attached to the second housing component 4. The assembly 14 can comprise a control valve for each of the ports. The control valves can be used to open or close fluid lines connected to the ports. In a preferred variant, the control valves are arranged directly on the second housing component 4. This means that the line paths of the ports can be kept to a minimum.

The vacuum port 14.1 can be used to set a negative pressure, in particular the pressure p_{V1}, in the chamber 15. For this purpose, the gas in the chamber is extracted by means of a pump (not shown), such that a defined negative pressure (“vacuum”) is present relative to the ambient pressure.

The auxiliary gas port 14.2 can be used to introduce an auxiliary gas, preferably nitrogen, into the chamber 15. This allows a defined positive pressure, in particular the pressure p_{H1}, to be provided in the chamber 15. The auxiliary gas can be supplied by a pump (not shown) or from a pressure tank (not shown).

The sensor port 14.3 can be used to provide a pressure sensor VP1 for measuring the pressure present in the chamber 15. The pressure to be set in the chamber 15 can be checked and set using the pressure sensor VP1.

The chamber 15 is used to accommodate an assembly 1 to be treated. The assembly 1 can consist of one or more workpieces, systems, or subsystems. The assembly 1 is held in a fixing device 8 and is characterized by the fact that it responds sensitively to pressure loads (positive or negative pressure) from time to time.

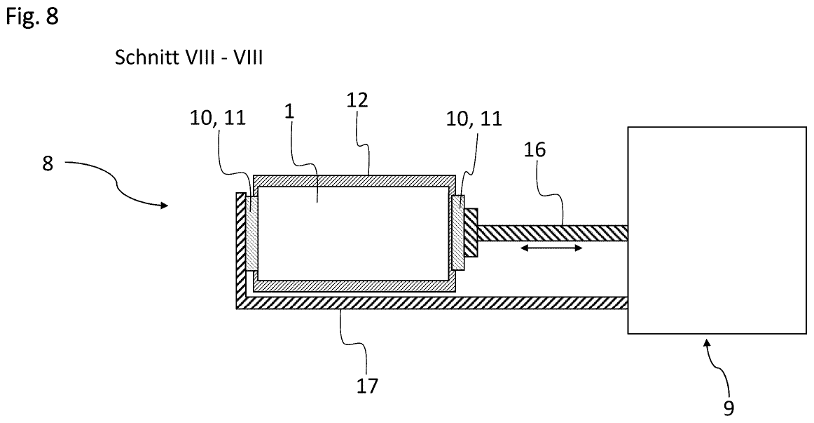

The fixing device 8 has a leg on which a second and/or third shaped piece 10, 11 are arranged. The end piece of the leg is connected to a clamping drive 9. In one variant, the leg is designed as an L-shaped leg 17, as shown in FIG. 8. The fixing device 8 also comprises a second straight leg 16. The straight leg 16 is connected to the clamping drive 9. The L-shaped leg 17 and/or the straight leg 16 can be adjusted using the clamping drive 9. In an alternative variant, a U-shaped leg can be provided instead of an L-shaped leg 17, wherein the two end pieces of the U-shaped leg can be connected to the clamping drive 9.

One version of the clamping drive 9 is electrically driven. In an alternative variant, the clamping drive 9 is pneumatically or hydraulically operated. The second and/or third shaped pieces 10, 11 can therefore be moved towards each other with the aid of the clamping drive 9 to clamp the assembly 1. This ensures that the assembly 1 is held securely inside the chamber 15. By using the second and/or third shaped pieces 10, 11, different shapes and sizes of assemblies 1 to be treated can be securely held and positioned in the fixing device 8. For this purpose, the second and/or third shaped piece 10, 11 is geometrically adapted to the respective assembly to be used, such that the opening 3 of the assembly 1 can be coupled in a fluid-tight manner to the connecting piece 2.1 of the adapter 2. In order to reduce or avoid the risk of damage to the assembly 1 when jamming, the second and/or third shaped pieces 10, 11 are made of an elastic plastic. The fixing device 8 is arranged on the first housing component 5 and projects from the first housing component 5 in the direction of the chamber 15 to be formed. In a preferred variant, the fixing device 8 is integral with the first housing component 5.

The first housing component 5 also comprises a shaped piece receptacle 5.1. In one variant, this can be manufactured as an integral part of the first housing component 5. The shaped piece receptacle 5.1 is used to accommodate a first shaped piece 12. The first shaped piece 12 is held in the shaped piece receptacle 5.1 by frictional locking and/or positive locking. For this purpose, in one variant, the first shaped piece 12 can be inserted into the shaped piece receptacle 5.1 by means of a press fit. In an alternative variant, the first shaped piece 12 can be coupled to the shaped piece receptacle 5.1 by means of a thread, a bayonet, or a clip connection. To prevent an assembly 1 from being damaged and/or deformed by the first shaped piece 12, the first shaped piece 12 comprises a material that is more elastic than the material of the assembly 1. In one variant, the first shaped piece 12 can be made of a plastic material. The first shaped piece 12 is used to align and position the assembly 1 within the chamber 15. In another variant, the first shaped piece 12 can be designed such that it aligns, positions, and holds the assembly 1 within the device A. For this purpose, the first shaped piece 12 can be configured as one or more parts. In a multi-part version of the first shaped piece 12, the individual shaped piece parts can be connected to each other such that they at least partially enclose the assembly 1. With the aid of the first shaped piece 12, the assembly 1 can be positioned in the chamber 15 such that an opening 3 of the assembly 1 can be connected to the adapter 2 in a fluid-tight manner.

In another variant, the first shaped piece 12 can be designed such that it acts as a displacement body within the chamber 15. This allows the defined pressure to be set more quickly in chamber 15.

The adapter 2 can be used to adjust the pressure within the assembly 1. For this purpose, the adapter 2 is inserted in a fluid-tight manner into the second housing component 4. For example, the adapter 2 can be screwed to the second housing component 4. This allows the adapter 2 to be easily removed for maintenance. The adapter 2 comprises an outlet piece 2.1. The outlet piece 2.1 is coupled to the opening 3 of the assembly 1 in a fluid-tight manner. For this purpose, the outlet piece 2.1 can have a seal (not shown) in one variant. The sealing effect can be improved by using a separate seal. In an alternative variant, the outlet piece 2.1 can comprise an integrally arranged conical chamber seal in the sealing area. The adapter 2 also comprises a filling port 2.2, a gas supply port 2.3, a second sensor port 2.4, and/or a control port 2.5.

A fluid can be fed into the assembly 1 by means of the adapter 2 using the filling port 2.2. A (positive pressure) pump (not shown) can preferably be provided for this purpose. In one variant, the assembly 1 can be configured as a battery or accumulator cell and the fluid can be configured as an electrolyte. In an alternative variant, the assembly 1 can be configured as a sensor unit and the fluid can be configured as an oil, in particular as a dielectric oil. In another variant, the assembly 1 is configured as an electronic unit with a housing, wherein the fluid is selected as an inert gas, preferably nitrogen or helium.

With the aid of the gas supply port 2.3, a negative pressure, in particular a negative pressure p_{V2}, can be set in the assembly 1 by means of the adapter 2. The vacuum can be created using a (suction) pump (not shown). In an alternative version, a positive pressure, in particular the pressure p_{H2}, can be set in the assembly 1 by means of the gas supply port 2.3. For this purpose, an additional auxiliary gas can be fed into the assembly 1 by means of the gas supply port.

A pressure sensor VP2 can be connected to the adapter 2 using the second sensor port 2.4. This makes it possible to determine the pressure within assembly 1. The control port 2.5 can be used to control the dosing opening of the adapter 2.

Multiple ports 14.1, 14.2, 14.3, 2.2, 2.3, 2.4, 2.5 are arranged in one variant on the same side of the device A, in particular on the side of the second housing component 4. This simplifies the cable routing on device A. This also makes it easier to access device A.

The adapter 2 can preferably have an adjustable piston 2.6. The adjustable piston 2.6 can be used to move the outlet piece 2.1 in the direction of the assembly 1. A defined positive or negative pressure is generated in the adapter chamber 2.8 to adjust the piston 2.6. For this purpose, a defined pressure Pₛ₁ is set by means of a chamber port 2.7. The fluid can be a gas, preferably nitrogen, or a liquid, preferably an oil. The adjustable piston 2.6 can be used to provide a secure and fluid-tight coupling for an opening 3 of the assembly 1 that is difficult to access.

Furthermore, the device A can comprise a volume ballast 13 (not shown), which can be arranged in the chamber 15. The volume ballast serves as a displacement body to be able to set the defined pressure in the chamber 15 more quickly. The volume ballast 13 is replaceably attached in the chamber 15. In one variant, the volume ballast 13 is releasably attached to an inner side of the first and/or second housing component 4, 5 by means of a clip connection. In an alternative variant, the attachment of the volume ballast 13 can be designed as a screw connection. In a special embodiment, a plurality of different or similar volume ballast units can be provided. This allows the volume of chamber 15 to be reduced in the best possible way.

In another variant, the volume ballast 13 can be designed such that it also assumes the function of the first shaped piece 12.

In another design of the device according to examples disclosed herein, the device comprises a vacuum chamber for accommodating the assembly 1 to be filled (or multiple assemblies 1 to be filled) and a filling adapter 2a for filling the assembly 1 to be filled for this purpose. The assembly 1 has a filling opening 3 which is in operative connection with the filling adapter 2a during filling.

The elements required for the operation of the filling adapter 2a are marked with the reference symbols pᵥ₂ (vacuum), p_{H2} (auxiliary gas), pₛ₁ (feed adapter), p_{S2} (dosing opening control) and P_{F2} (filling medium).

The vacuum chamber 5a of the device is releasably assembled from a base plate 4a and a vacuum pressure trough 5a.

The base plate 4a comprises a structural unit on its upper side that can be brought into operative connection with the vacuum chamber. For this purpose, this structural unit has ports for evacuating the vacuum chamber and for feeding auxiliary gas into the vacuum chamber. In the drawing, the ports are labeled with the respective applied pressure pᵥ₁ for the vacuum and P_{H1} for the auxiliary gas. This structural unit also comprises a VP1 vacuum pressure sensor. Furthermore, the base plate 4a has an opening in which the filling adapter 2a is supported.

The base plate 4a comprises at least two closure elements arranged opposite each other at the front end sections for an active connection with the vacuum pressure trough 5a. In the drawing, these closure elements are labeled with the respective pressure p_{C1a} or p_{C1b}. These closure elements are preferably designed as pawls with a contour that is congruent with the contour on the associated section of the vacuum pressure trough 5a.

Furthermore, the base plate 4a comprises at least one seal 6 on its underside and a centering device 7 for an operative connection with the vacuum pressure trough 5a. The seal 6 is preferably designed with two round seals running parallel to each other, each of which being arranged in a groove on the underside of the base plate 4a. The centering device 7a (preferably multiple such centering devices 7a are provided) is designed as a locking pin with a contour that is congruent with the contour of an opening on the associated section of the vacuum pressure trough 5a.

A fixing device 8 which is equipped with a clamping drive 9 for fixing the position of the assembly 1 to be filled is arranged on the underside of the base plate 4a. The clamping drive 9 is equipped with replaceable shaped pieces 10 and 11 for fixing the position of the assembly 1 to be filled. The elements required to control the clamping drive 9 are labeled with reference symbols p_{S3} and p_{S4}.

The vacuum pressure trough 5a has a U-shaped cross-section. The upper end section of the side walls in this case has a flange-like, circumferential projection that comprises a section leading outwards and a section leading inwards. The section leading outwards has a contour that is congruent with the contour of the pawls on the closure elements on the associated section of the base plate 4a. The section leading inwards has openings that are congruent with the contour of the locking pins 7 on the associated section of the base plate 4a.

The vacuum pressure trough 5a is equipped with replaceable shaped pieces 12 on the upper side of its base surface for fixing the position of the assembly 1 to be filled. Furthermore, a batch-specific volume ballast 13 can be arranged on the top of the base surface. This volume ballast 13 is designed such that the free residual volume within the vacuum pressure trough 5a is largely reduced.

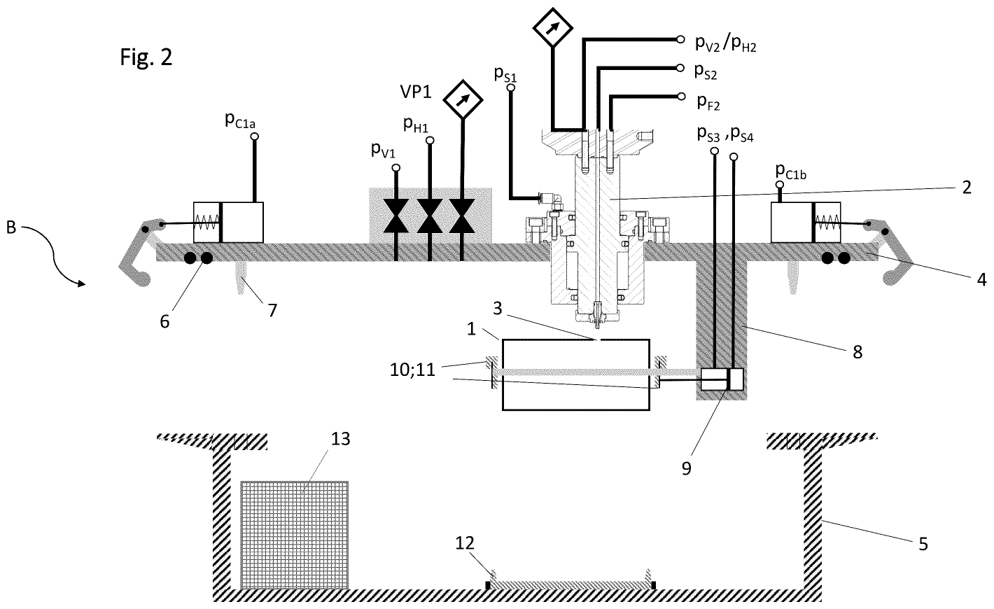

FIG. 2 shows an operating position in which the base plate 4a and the vacuum pressure trough 5a are separate components.

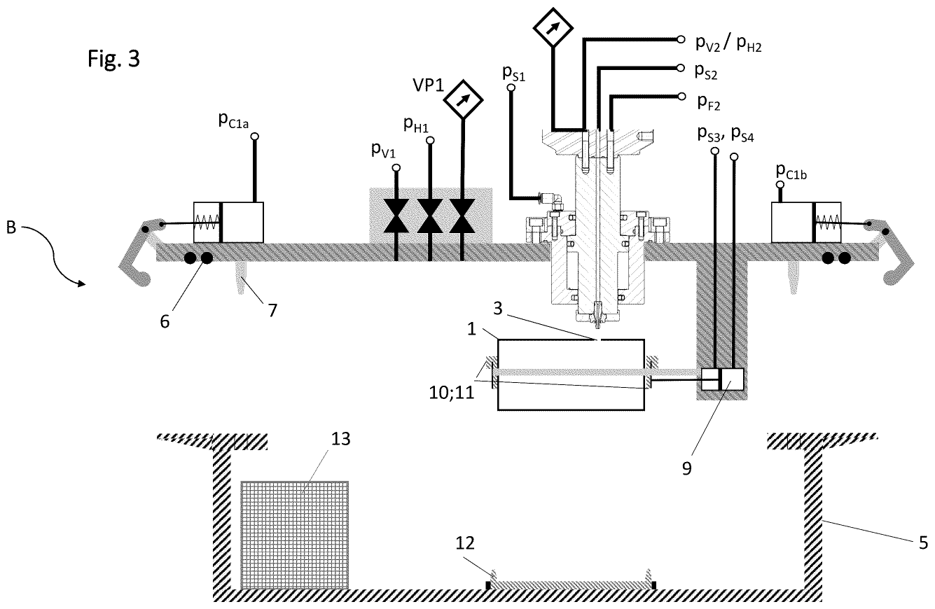

FIG. 3 shows an operating position in which the base plate 4a and the vacuum pressure trough 5a are still separate components. In this position, however, the assembly 1 to be filled is clamped in a fixed position by means of the clamping drive 9 and the shaped pieces 10 and 11.

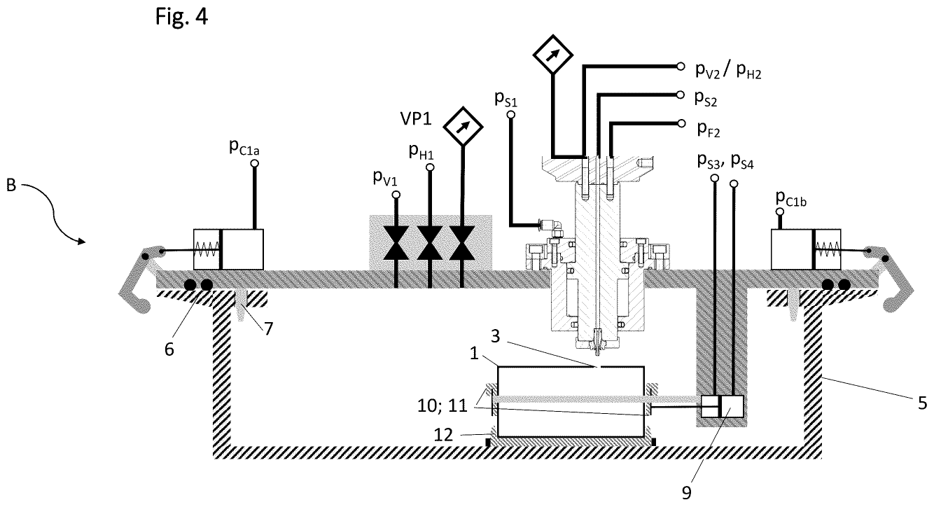

FIG. 4 shows an operating position in which the base plate 4a and the vacuum pressure trough 5a are aligned in a fixed position relative to each other by means of the centering devices 7 and lie on top of each other. The assembly 1 to be filled is already resting on the top of the base surface of the vacuum pressure trough 5a.

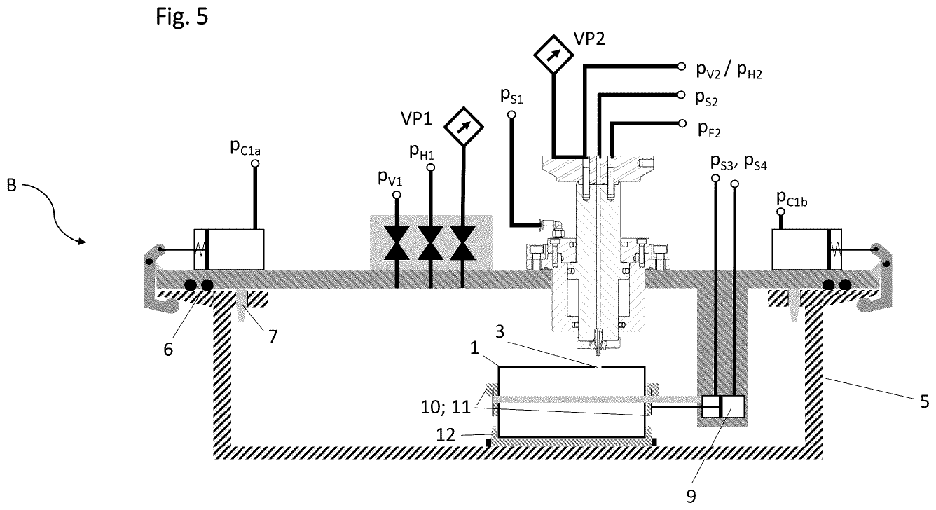

FIG. 5 shows an operating position in which the base plate 4a and vacuum pressure trough 5a, which are fixed in position relative to each other, are now clamped by the closure elements, such that a vacuum pressure chamber 5a is functionally designed. In this representation, the vacuum pressure sensor associated with the filling adapter 2a is labeled with a reference symbol VP2.

FIG. 5 thus shows the operating position of the device, in which pressure testing, evacuation, and filling of non-vacuum-resistant or non-pressure-resistant assemblies can be carried out by means of vacuum pressure filling or vacuum volume filling. Typical applications in this regard are testing and filling sensors with oil or testing and filling batteries with electrolyte.

When using the device according to examples disclosed herein, the following functional sequence results:

In the operating position as shown in FIG. 5, the filling tool (consisting of base plate 4a with filling adapter 2a and the other elements mounted on the base plate 4a) and the vacuum pressure trough 5a are brought together to form a chamber that is sealed off from the environment in a vacuum resistant and pressure-resistant manner. In the vacuum pressure chamber, the assembly 1 is additionally sealed at its filling opening 3a by means of the filling adapter 2a in order to be able to carry out a pressure test, vacuum test, and filling by means of this adapter, in which different media are used simultaneously in the assembly 1 and in the surrounding vacuum pressure chamber, the pressures of which can be controlled separately from one another such that different pressure differences between the internal pressure of the assembly 1 and the surrounding chamber can be set.

Assembly 1 is fixed in the vacuum pressure chamber. The fixing device 8 used for this purpose can—as shown in the drawing—be arranged either on the base plate 4a or in the vacuum pressure trough 5a. The specific design depends on the type of components, shape, weight and automation of the loading process.

The assembly 1 is fixed in place by mechanical movement of the clamping drive 9 (FIG. 2). Replaceable shaped pieces 10; 11 enable the locking of different sized assemblies 1 (batch production) and position the filling opening 3a of the assembly 1 exactly under the filling adapter 2a.

Depending on the specific size of the assembly 1, an additional batch-specific volume ballast 13 can be replaceably attached in the vacuum pressure trough 5a to reduce the volume of the resulting chamber and thus the consumption of the auxiliary gas P_{H1} during the process and to optimize the evacuation and pressure control speed and accuracy.

The base plate 4a with the filling adapter 2a and the vacuum pressure trough 5a are centered against each other and closed and sealed with a suitable closing mechanism. The specific type and number of closures depends on the application. The drawing shows examples of two pneumatically driven closing elements that are moved by applying pressures p_{C1a} and p_{C1b}.

Alternatively, it is also sufficient to press the vacuum pressure trough 5a against the base plate 4a with the filling adapter 2a using the motion drive. During this movement, the assembly 1 is centered on the shaped piece 12. The filling opening 3a of the assembly 1 is now centered under the filling adapter 2a at a defined height.

The filling adapter 2a is pressed onto the assembly 1 by the integrated pneumatic drive with a contact pressure that can be controlled by means of pₛ₁ and sealed with a seal at the filling opening of the filling adapter 2a.

By setting different pressures inside (p_{V2}/p_{H2}) and outside (p_{V1}/p_{H1}) of assembly 1, this assembly 1 can be subjected to pressure difference tests. The actual set pressures are measured by means of the VP1 and VP2 vacuum pressure sensors and controlled as required. During the evacuation of the assembly 1, the vacuum pressure trough 5a is also evacuated in a controlled manner, wherein the vacuum p_{V1} and p_{V2} can be applied from separate vacuum sources. Once the desired final vacuum has been reached, the assembly 1 is filled with the medium to be filled by means of a separate line in the filling adapter 2a and, at the same time, the pressure in the vacuum pressure trough 5a is increased.

As soon as the assembly 1 is completely filled with the medium, the pressure of the filling medium p_{F2} can be further increased and at the same time the pressure of the auxiliary gas p_{H1} can be controlled such that, despite a high filling pressure, which is necessary, for example, for wetting or soaking the smallest fine-pored structures of components (e.g. sensors) or materials (e.g. electrode material of a battery cell) located in the assembly 1, the pressure difference remains small enough that even a thin outer wall of the assembly 1 is not deformed or that positive pressure safety devices incorporated therein are not triggered.

Once filling is complete, a controlled pressure setting p_{V1}/p_{H1}, p_{V2}/p_{H2} and p_{F2} can be used to equalize the pressure such that the filling adapter 2a remains as drip-free as possible after it has been detached or such that the filling line in the filling adapter 2a can be cleaned quickly and in a controlled manner using a positive pressure p_{H1}. The pressure in the vacuum pressure chamber is equalized to the ambient pressure. The vacuum pressure chamber is then opened by releasing the base plate 4a and vacuum pressure trough 5a from each other and the assembly 1 is removed manually by a worker or by a suitable automation device.

Finally, it should be pointed out that the components described above can also be present multiple times in such a device, such that simultaneous parallel processing of multiple assemblies 1 is possible in a common process sequence.

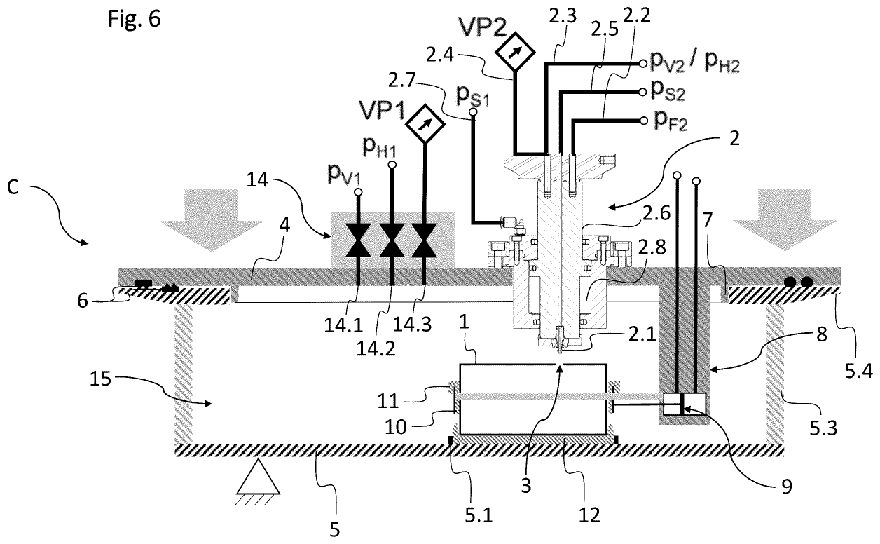

Another embodiment of a device C according to examples disclosed herein is disclosed in FIG. 6. The device C comprises a first housing component 5, which has a U-shaped cross-section. The first housing component 5 also comprises a flange-like circumferential projection 5.4 at the upper end section of the base side walls 5.3. This circumferential projection 5.4 comprises a section leading outwards and a section leading inwards. The first housing component 5 consists of multiple components joined together. In one variant, at least one component includes a different material than the other components. This makes it possible to provide a particularly cost-effective and/or particularly dimensionally stable housing component. Preferably, the bottom side walls 5.3 and the circumferential projection 5.4 of the first housing component 5 are made of a cast metal, preferably a gray cast metal. This has the necessary dimensional stability and can be produced cost-effectively.

The sections of the first housing component 5 leading outwards and inwards serve as a coupling area to the second housing component 4. The second housing component 4 has a plate-shaped cross section. The second housing component 4 also comprises a component section. This component section serves as a positioning device 7. The positioning device 7 has a smaller diameter than the circumferential projection 5.4 such that the positioning device 7 can position itself on the circumferential projection 5.4 of the first housing component 5. Preferably, the circumferential projection 5.4 of the first housing component 5 has a chamfer.

This makes it easier to position the second housing component 4 on the first housing component 5. In an alternative embodiment (not shown), the positioning device 7 of the second housing component 4 has a larger diameter such that the first housing component 4 can position itself on the circumferential projection 5.4 of the second housing component 5.

Seals 6 are provided in the coupling area. In one variant, the seals 6 can be designed as separate seals 6 and connected to the first and/or the second housing component 4, 5. The seals 6 can be designed as ring seals, flat seals or shaped seals with protruding sealing lips.

In a particularly preferred embodiment, a seal is arranged on the first housing component 5 and another seal is arranged on the second housing component 4. This makes it possible to seal the chamber 15 particularly well against the ambient pressure.

The two housing components 4, 5 shown in FIG. 6 are pressed together with the aid of a retaining force and thus coupled in a fluid-tight manner with respect to the environment. In one variant, the first housing component 5 can rest on a support, such as a processing table, or be firmly connected thereto. The second housing component 4 is pressed onto the first housing component 4 by a retaining force. In an alternative variant, the retaining force can act on both housing components 4, 5, such that the housing components 4, 5 are pressed against each other. In another variant, the second housing component 4 can rest on a support or be firmly connected thereto, while the first housing component 5 is pressed onto the second housing component 4 by a retaining force. The retaining force can preferably be provided by a separate hold-down device. The retaining force must be present throughout the pressure test, evacuation, and/or filling in order to seal the device C against the environment.

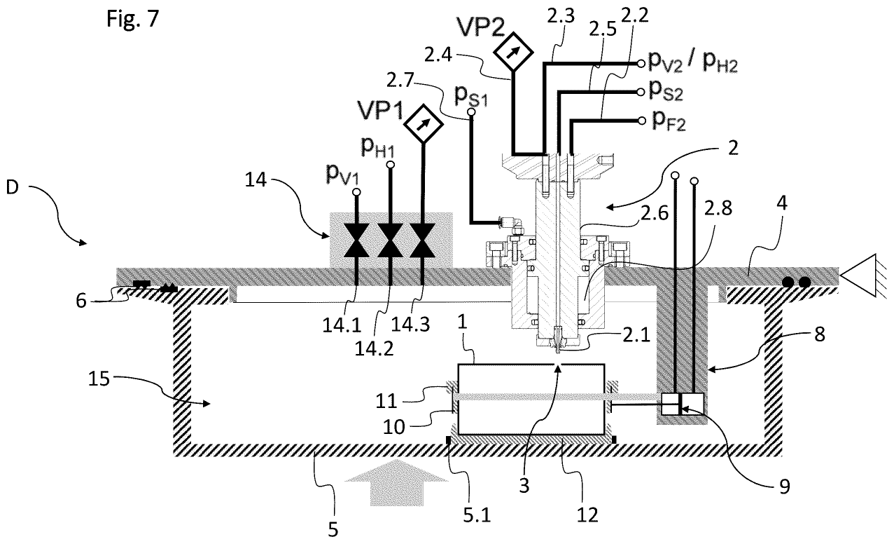

FIG. 7 discloses another embodiment of examples disclosed herein in the form of a device D for pressure testing, evacuation, and/or filling, in which the method according to examples disclosed herein is described with the following steps.

Device D is provided for carrying out the method according to examples disclosed herein. The device D comprises a first housing component 5 and a second housing component 4. The second housing component 4 comprises an adapter 2. An assembly 1 to be treated is inserted into the device D. In one variant, the device D is configured for pressure testing, evacuating, and filling battery cells and/or accumulator cells. In this variant, the assembly is a battery cell and/or an accumulator cell. Preferably, the assembly 1 can be inserted into the device D together with a first shaped piece 12. To do this, the assembly 1 is first inserted into the first shaped piece 12.

The assembly 1 and the first shaped piece 12 are then inserted into the shaped piece holder 5.1 of the first housing component 5. In an alternative preferred embodiment of the method, the first shaped piece 12 can be inserted into the device D first. The assembly 1 is then inserted into the first shaped piece 12, which is now in the device D. In an alternative variant, the device D comprises a fixing device 8 for gripping and holding an assembly 1. This allows an assembly 1 to be picked up from a storage location with the aid of the fixing device 8 and to be inserted into the device D. Preferably, the assembly 1 is inserted into the device D with the aid of the fixing device 8 such that the assembly 1 is aligned with the first shaped piece 12. Inserting the assembly 1 is made much easier, in particular with large and/or bulky assemblies, in that the housing is divided into two parts. After inserting the assembly 1 to be treated, the device D is closed such that the device D forms a chamber 15 that is fluid-tight against the environment.

In the embodiment shown in FIG. 7, the second housing component 4 is held stationary, in particular laterally. The first housing component 5 is pressed against the second housing component 4 by a retaining force and thus closed.

The assembly 1 is arranged in the chamber 15. In one variant, the assembly 1 is filled with a fluid, in particular with an electrolyte. Filling takes place at a defined positive pressure or according to a defined volume to be filled. Filling takes place over a predefined time, up to a predefined volume and/or a predefined pressure within the assembly 1.

In a variant of the method according to examples disclosed herein, the device D is provided and the assembly 1 is inserted. Preferably, the assembly 1 is aligned in the chamber 15 with the aid of the first shaped piece 12 such that an opening 3 of the assembly 1 is aligned with the adapter 2. The adapter 2 can then be coupled fluid-tightly to the opening 3 of the assembly 1. Preferably, the adapter 2 comprises an outlet piece 2.1 for this purpose, which preferably comprises a seal. Fluid-tight coupling of the assembly 1 with the adapter 2 allows different pressures to be set in the chamber 15 and the assembly 1. In another process step, the chamber 15 is pressurized with a defined first negative pressure. A defined second negative pressure is applied to assembly 1. The chamber 15 and assembly 1 are evacuated such that a virtually constant pressure ratio is set between the chamber 15 and the assembly 1. Preferably, the pressures in the chamber 15 and in the assembly 1 are measured after the chamber 15 and the assembly 1 have been evacuated. This can be used to check whether the predefined negative pressure has been set. For this purpose, a pressure sensor VP1 can preferably be connected to the chamber 15 by means of a first sensor port 14.3. The sensor port 14.3 preferably comprises a switching valve. Another pressure sensor VP2 can preferably be connected to the assembly 1 by means of a second sensor port 2.4. Both sensor connections are connected to a control unit (not shown). This makes it easy to control the sensors and/or valves. A pressure test of the assembly 1 can then be carried out by changing one of the set pressures in the chamber 15 and/or the assembly 1. Preferably, the pressure of chamber 15 is changed. When doing so, the set negative pressure of assembly 1 is maintained. After changing the set pressure in chamber 15 and/or assembly 1, the set pressures in chamber 15 and/or assembly 1 are measured again. The measured pressures are then compared with the measured pressures of the evacuated chamber 15 and the evacuated assembly 1. The control unit then compares the measured pressures. By comparing the measured pressures, a leak in chamber 15 and/or assembly 1 can be determined. The assembly 1 is then filled with a fluid at a defined positive pressure or a defined volume. Filling takes place over a predefined time, up to a predefined volume and/or a predefined pressure. The chamber 15 is filled with an auxiliary gas in a time adjusted way or at the same time. The auxiliary gas can be nitrogen in one variant, as this is inert for most materials. The chamber 15 is filled at a defined positive pressure depending on the pressure specified or measured in the assembly 1. This allows a predefined positive pressure to be set in the assembly 1 to the chamber 15. This makes it possible to keep the load applied to the assembly 1 low despite the positive pressure during filling in the assembly 1. In a preferred variant, the pressure in the assembly 1 can be further increased for a defined time after the assembly 1 has been completely filled with the fluid. This means that highly porous materials, in particular, can be saturated with the fluid more quickly.

After completion of the specified filling of assembly 1, in one variant the pressure within assembly 1 is set to the pressure of chamber 15. The outlet piece 2.1 of the adapter 2 is then detached from the assembly 1. The pressure in the adapter chamber 2.8 is adjusted for this purpose. The auxiliary gas is then drained from the chamber 15, in particular by means of a pump. This allows the pressure in chamber 15 to be set to ambient pressure. The device D is then opened by decoupling the first housing component 5 from the second housing component 4. The filled assembly 1 can then be removed from the device D and another assembly can be placed in the device D for treatment. Assembly 1 can be inserted and removed manually by a worker or automatically with the aid of a robot device (not shown).

In an alternative variant, the pressure inside the assembly 1 and in the chamber 15 is set to ambient pressure almost simultaneously. The outlet piece 2.1 of the adapter 2 is then detached from the assembly 1. The two housing components 4, 5 of the device D are then, or approximately at the same time, released from each other so that the assembly 1 can be removed from the device D.

### LIST OF REFERENCE NUMERALS

A first device
B second device
C third device
D fourth device
1 assembly group
2 adapter
2a filling adapter
2.1 outlet piece
2.2 filling port
2.3 gas supply port
2.4 second sensor port
2.5 control port
2.6 adjustable piston
2.7 chamber port
2.8 adapter chamber
3 opening
3a filling opening
4 second housing component
4a base plate
4.1 side walls
4.2 ceiling wall
5 first housing component
5a vacuum pressure trough
5.1 shaped piece receptacle
5.2 ground plate
5.3 bottom side walls
5.4 projection
6 seal
7 positioning device
7a centering device/locking pin on base plate
8 fixing device
9 clamping drive
10 second shaped piece
11 third shaped piece
12 first shaped piece
13 volume ballast
14 structural unit
14.1 vacuum port
14.2 auxiliary gas port
14.3 first sensor port
15 chamber
16 straight leg
17 L-shaped leg
VP1 vacuum pressure sensor
VP2 vacuum pressure sensor
p_{c1a} pressure at closing element
p_{c1b} pressure at closing element
P_{F2} pressure of filling medium
p_{H1} auxiliary gas pressure
p_{H2} filling adapter auxiliary gas pressure
p_{S1} filling adapter pressure feed
p_{S2} dosing opening pressure control
p_{S3} clamping drive pressure control
p_{S4} clamping drive pressure control
P_{V1} vacuum pressure
p_{V2} filling adapter vacuum pressure

1. A device for pressure testing, evacuation, and/or filling of an assembly, the device comprising:
a first housing component; and
a second housing component, wherein the second housing component is coupled to the first housing component such that a chamber is formed for accommodating the assembly to be treated, wherein the device includes an adapter for pressure testing, evacuation, and/or filling of the assembly.

2. The device according to claim 1, wherein the adapter includes an outlet piece, and wherein the outlet piece is aligned and configured such that, during a pressure testing, evacuation, and/or filling process, the outlet piece can be coupled in a fluid-tight manner to an opening of an assembly to be treated.

3. The device according to claim 2, wherein the device includes a first shaped piece, with the aid of which an assembly to be treated can be aligned relative to the adapter, and wherein the device includes a shaped piece receptacle and the first shaped piece is adapted to the dimensions and/or the shape of the assembly to be treated such that the outlet piece can be coupled in a fluid-tight manner to the opening during a pressure testing, evacuation, and/or filling process.

4. The device according to claim 1, wherein the device includes a fixing device with a clamping drive for fixing the position of the assembly, and wherein the clamping drive is equipped with replaceable second and third shaped pieces for fixing the position of the assembly.

5. The device according to claim 1, wherein the device includes a line port, in particular a vacuum port and an auxiliary gas port, and/or a first sensor port, wherein the ports preferably are integrated in a structural unit, and the adapter includes a filling port, a gas supply port, and/or a second sensor port.

6. The device according to claim 5, wherein multiple ports of the device and multiple ports of the adapter are arranged on the same side of the device, in particular on one side of the second housing component.

7. The device according to claim 1, wherein the device includes a volume ballast, wherein the volume ballast is replaceable and is designed and/or selected depending on the assembly to be treated, and wherein the volume ballast is arranged within the chamber such that a free residual volume is reduced.

8. The device according to claim 1, wherein the second housing component is aligned with the first housing component by a positioning device, in particular by a centering device, such that the outlet piece of the adapter can be connected in a sealed manner to the opening of the assembly to be treated for a pressure test, evacuation, and/or filling operation.

9. The device according to claim 1, wherein the first housing component and/or the second housing component include a closure element, wherein the closure element releasably connects the first housing component to the second housing component, wherein a seal is provided in the coupling area of the housing components on the first housing component and/or on the second housing component, which seal is at least partially compressed by the closure element between the two housing components.

10. The device according to claim 1 for pressure testing, evacuation, and filling of a non-vacuum-resistant or non-pressure-resistant assembly by means of vacuum pressure filling or vacuum volume filling, wherein the chamber is configured as a vacuum chamber, wherein the device comprises a vacuum chamber for accommodating the assembly to be filled and a filling tool for filling the assembly to be filled, and wherein the second housing component is configured as a base plate and the first housing component is designed as a vacuum pressure trough, wherein, the vacuum chamber of the device is releasably assembled from a base plate and a vacuum pressure trough.

11. The device according to claim 1, wherein the base plate includes on its upper side a structural unit which can be brought into operative connection with the vacuum chamber and for this purpose includes ports for evacuating the vacuum chamber and for supplying auxiliary gas into the vacuum chamber as well as a vacuum pressure sensor, wherein an opening is formed in the base plate in which a filling adapter is supported, wherein the base plate includes on its end-face ends at least two closure elements arranged opposite one another for an operative connection with the vacuum pressure trough, and wherein the base plate includes on its underside at least one seal and a centering device for an operative connection with the vacuum pressure trough, as well as a fixing device with a clamping drive for fixing the position of the assembly to be filled.

12. The device according to claim 1, wherein the closure elements on the base plate are designed as pawls and have a contour that is congruent with the contour on the associated section of the vacuum pressure trough.

13. The device according to claim 1, wherein the seal on the base plate is designed with two round seals running parallel to one another, each of which being arranged in a groove on the underside of the base plate.

14. The device according to claim 1, wherein the centering devices on the base plate are designed as locking pins and have a contour which is congruent with the contour of an opening on the associated section of the vacuum pressure trough.

15. The apparatus according to claim 1, wherein the vacuum pressure trough includes a U-shaped cross-section, wherein a flange-like circumferential projection is formed on the upper end section of the side walls, which projection includes a section leading outwards and a section leading inwards, wherein the section leading outwards has a contour which is congruent with the contour of the locking pawls on the closure elements on the associated section of the base plate, and wherein the section leading inwards has openings which are congruent with the contour of the locking pins on the associated section of the base plate.

16. The device according to claim 15, wherein the vacuum pressure trough is equipped on the upper side of its bottom surface with replaceable shaped pieces for fixing the position of the assembly be filled.

17. The device according to claim 15, wherein a batch-specific volume ballast can be arranged on the upper side of the bottom surface of the vacuum pressure trough.

18. The device according to claim 17, wherein the batch-specific volume ballast is designed such that the free residual volume within the vacuum pressure trough is largely reduced.

19. The method for pressure testing, evacuation, and/or filling of an assembly, the method comprising:
providing a device with an adapter, in particular a device according to claim 1, for accommodating an assembly to be treated;
inserting the assembly to be treated into the device;
closing the device, such that the device forms a chamber which is fluid-tight with respect to the environment and in which the assembly is arranged; and
filling the assembly with a fluid at a defined positive pressure or a defined volume over a predefined time, up to a predefined volume and/or a predefined pressure.

20. The method according to claim 19, further including:
fluid-tight coupling of the adapter to an opening of the assembly before the assembly is filled at a defined positive pressure;
pressurizing the chamber at a defined first negative pressure and the assembly at a defined second negative pressure, such that a virtually constant pressure ratio is established between the pressure in the chamber and the pressure inside the assembly before the assembly is filled at a defined positive pressure;
preferably measuring the pressures present in the chamber and in the assembly before filling the assembly at a defined positive pressure; and
subsequent filling of the chamber with an auxiliary gas at a defined positive pressure depending on the pressure specified or measured in the assembly, such that there is a predefined positive pressure in the assembly relative to the chamber,
wherein, after completion of the predefined filling of the assembly, the auxiliary gas of the chamber is drained and the pressure of the chamber is set to ambient pressure.

21. The method according to claim 20, wherein, after measuring the pressures in the chamber and in the assembly, the method further includes:
changing the set pressure in the chamber and/or the assembly;
re-measuring the set pressures in the chamber and/or the assembly; and
comparing the measured pressures of the chamber and/or the assembly before and after the pressure change.

22. The method according to claim 19, further including:
providing a first shaped piece;
inserting the first shaped piece into the device, wherein the first shaped piece is aligned with a shaped piece receptacle of the device;
gripping an assembly to be treated with the fixing device of the device from a storage location; and
inserting the gripped assembly into the device, such that the assembly is aligned for fluid-tight coupling with the adapter with the aid of the first shaped piece.
